(19) United States
(12) Patent Application Publication
(10) Pub. No.: US 2008/0238800 A1
(43) Pub. Date: Oct. 2, 2008

(54) Balanced Antenna Devices

(76) Inventor: Brian Collins, Cambridge (GB)

Correspondence Address: Pearl Cohen Zedek Latzer, LLP, 1500 Broadway, 12th Floor, New York, NY, 10036, US

(21) Appl. No.: 12/064,270

(22) PCT Filed: Sep. 18, 2006
(86) PCT No.: PCT/GB06/50292

§ 371 Date: Feb. 20, 2008

(30) Foreign Application Priority Data
Sep. 19, 2005 (GB) 0518996.4

(51) Int. Cl. H01Q 9/28

(52) U.S. Cl. 343/795

(57) ABSTRACT

A balanced antenna comprising a dipole with first and second radiating arms, the radiating arms being provided with a balanced transmission line for connection to a feed, the balanced transmission line comprising first and second conductors connected to each other by a short-circuit conductor, and in which the antenna device is fed by applying a potential difference across the first and second conductors. The antenna device may be fed with an unbalanced feed, and is significantly smaller than a typical balanced dipole antenna device configured for operation at the same frequency.

The present invention relates to balanced antenna devices, in particular but not exclusively for use in cellular radio terminals and data terminals.

### BACKGROUND

Many modern cellular radio terminals and data terminals, such as mobile telephone handsets, PDAs and laptop computers, make use of unbalanced antennas such as monopoles, planar inverted-F antennas (PIFAs), dielectric antennas, etc. The term ‘unbalanced’ means that what appears to be the antenna is only half of the radiation mechanism, with the handset or terminal chassis acting as the other half. Here, chassis is a general term for the printed circuit board (PCB) together with any conductive components and assemblies connected thereto, typically including a battery, keyboard or keypad, display housings and any conductive paint applied to the casing or housing of the terminal to enhance electromagnetic compatibility (EMC) performance. The chassis and its associated conductive components form what may be regarded as the functional radio frequency ground, often referred to as the groundplane.

Unbalanced antennas have the advantage of being small, low cost, easy to design and easy to drive from an unbalanced feed mechanism such as a co-axial cable, microstrip transmission line, coplanar waveguide, etc. It is the nature of an unbalanced antenna that it has only one input terminal, so currents in the antenna are supported by equivalent currents flowing in the groundplane Unfortunately, the groundplane in small handheld devices is small compared with the operating wavelength, sometimes as little as one half wavelength long, and in these circumstances there is a price to be paid for using the chassis as part of the antenna: if the chassis or groundplane size is changed, or other components are moved round on the chassis or groundplane, the electrical characteristics of the antenna change and it has to be redesigned. This means that a single antenna design generally cannot be used for a variety of different applications.

There is now an increasing requirement to provide additional radio consumer electronics into cellular radio terminals and data terminals. An example is the reception of Global Positioning System (GPS) or similar satellite signals such that a terminal can determine its physical location. Receiving GPS signals is one way to meet the US Federal Communications Commission (FCC) mandate for “Enhanced 911”, which requires all US wireless phone companies to begin offering improved location capabilities on their networks. GPS also allows handset users to make use of location-based services. Upgrading a handset to include GPS facilities means the addition of appropriate software, integrated circuits and an appropriate antenna. It is preferable for this package to be easily installed on PCBs of many different shapes and sizes, without considerable customisation, and so unbalanced PIFAs and monopoles are unattractive for these applications. Similar arguments apply to other types of radio consumer electronics such Bluetooth®, WLAN, etc.

An alternative approach is to make use of a balanced antenna. A balanced antenna has two terminals and is complete of itself; it does not of necessity need to make use of any other components such as a chassis or groundplane Any currents induced in the groundplane by the radiating currents flowing in the antenna are by nature symmetrical, so there is no net current induced in the groundplane; it is therefore more immune to detuning caused by changes in the groundplane. Unfortunately, these advantages come at a price: a balanced antenna is twice the length of its unbalanced counterpart, which is a disadvantage when space is at a premium.

Probably the simplest and best-known example of a balanced antenna is the dipole, but like most balanced antennas a dipole works best in free space away from other conductors. The problem with using dipoles for mobile communications is that modern handset PCBs have a full groundplane, with the antenna usually positioned a tiny fraction of a wavelength above the groundplane.

### BRIEF SUMMARY OF THE DISCLOSURE

Embodiments of the present invention seek to provide a balanced antenna device that operates without a groundplane, but is typically much smaller than a traditional dipole antenna.

According to the present invention, there is provided a balanced antenna comprising a dipole with first and second radiating arms, the radiating arms being provided with a balanced transmission line for connection to a feed, the balanced transmission line comprising first and second conductors connected to each other by a short-circuit conductor, and in which the antenna device is fed by applying a potential difference across the first and second conductors.

The short-circuit conductor serves to limit excitation to the region of the transmission line and the radiating arms. This means that circuitry arrangements in the remainder of a device to which the antenna is connected do not affect the balance of the antenna circuit.

The arrangement is electrically balanced and can be excited by a voltage applied across the balanced transmission line.

In practical embodiments, the feed voltage can be provided by means of a feed transmission line which may be in the form of a coaxial cable, microstrip line, co-planar waveguide or other convenient geometry. The feed transmission line is connected such that a balanced driving voltage is set up between the first and second conductors. The configuration of the feed may be regarded as forming a balanced-to-unbalanced transition, i.e. a balun.

In some embodiments, the feed may be a balanced feed, while in others the feed may be an unbalanced feed.

The radiating arms of the dipole are preferably arranged in substantially parallel planes, and may be linearly coextensive in a given direction (e.g. the antenna device has a configuration similar to that of a tuning fork).

Alternatively, the radiating arms of the dipole may be folded or have a meandering configuration in their respective planes. Although the radiating arms of the dipole may be coextensive, it has been found that displacing the arms with respect to each other so that they do not follow exactly the same path in their respective planes can provide improved bandwidth.

Likewise, although the radiating arms may be of the same length, it has been found that arms having different lengths lead to improved bandwidth.

The radiating arms of the dipole may lie in different planes not coplanar with the feeding transmission lines.

In one embodiment of the present invention, the antenna device comprises a dielectric substrate having first and second opposed surfaces, with the first radiating arm of the dipole being formed on the first surface of the substrate, and the second radiating arm of the dipole being formed on the second, opposed surface of the substrate. The substrate may be a printed circuit board (PCB) substrate, with the first and second radiating arms being formed as conductive tracks extending from first and second conductive groundplanes formed respectively on the first and second surfaces of the substrate. It will be understood that in this embodiment, the first and second groundplanes are parallel and do not extend between the first and second radiating arms, but are in fact in the same planes as their respective radiating arm.

Each radiating arm is connected at one end to its respective groundplane by means of one conductor of the parallel transmission line. The feed (which may be balanced or unbalanced) may connect to each arm at a location near to the point of connection to the groundplane. The feed conductor may pass through the substrate and then be connected to the appropriate transmission line conductor.

In order to reduce or reject common mode interference, the addition of some reactance between one or both radiating arms and its or their respective groundplane may be provided, for example by way of a capacitive and/or inductive connection between the arm and its groundplane. Such connections may use discrete capacitors and/or inductors or may provide the required electrical characteristics using standard printed circuit techniques.

While this embodiment of the present invention is effective, it does not make the best possible use of space, since the radiating arms must be formed on parts of the dielectric substrate that are otherwise free of conductive material. This means that the dielectric substrate cannot be made as small in area as possible. It is generally desirable for the main chassis or PCB of a small radio device to be populated as fully as possible with components so as to minimise the overall size. This means that groundplane removal in areas of the PCB is undesirable, since these areas cannot then be populated with components.

Accordingly, in a particularly preferred embodiment of the present invention, the antenna device is formed as a dipole with first and second radiating arms located preferably in parallel planes as hereinbefore described, and wherein the antenna device is mounted on a conductive groundplane of a PCB so that the parallel planes of the radiating arms are substantially perpendicular to the PCB. Each radiating arm is connected at one end to the conductive groundplane, and a common feed (balanced or unbalanced) is provided between the radiating arms. For structural stability, the radiating arms are preferably formed on opposing surfaces of a dielectric substrate or are supported by an appropriate dielectric carrier.

This arrangement is possible due to the small size of the antenna device of embodiments of the present invention. In other words, the extent of projection of the radiating arms and their carrier or substrate above the PCB is small and easily contained within, for example, a mobile telephone handset housing.

By way of illustration, a GPS antenna made in accordance with an embodiment of the invention has been incorporated into the short side of a plug-in flash computer memory card (e.g. an SD card) such that the antenna protrudes from the device into which the antenna is plugged.

Embodiments of the present invention may further provide antenna devices for dual- or multi-band operation by employing a dipole or multiple dipole elements adapted for dual- or multi-band operation in accordance with known techniques. Such techniques include dipoles with multiple arms of different lengths [e.g. Raj, M. Joseph, B. Paul and P Mohanan, “Compact planar multiband antenna for GPS, DCS, 2.4=5.8 GHz WLAN applications”, R. K. ELECTRONICS LETTERS, Vol. 41, No. 6, 2005] and the inclusion of parasitic elements [e.g. Xing Jiang, Simin Li and Guangjie Su, “Broadband planar antenna with parasitic radiator”, ELECTRONICS LETTERS, Vol. 39, No. 23, 2003] to obtain dual, multiple or broadband operation. Other known methods are to include inductive, or resonant, ‘traps’ along the dipole arms or two use multiple feed points.

Throughout the description and claims of this specification, the words ‘comprise’ and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers and characteristics described in conjunction with a particular aspect, embodiment or example of the invention are to be understood to be applicable to any other aspect, embodiment or example described herein unless incompatible therewith.

### BRIEF DESCRIPTION OF THE DRAWINGS

For a better understanding of the present invention and to show how it may be carried into effect, reference shall now be made by way of example to the accompanying drawings, in which:

FIG. 1 shows a dipole configured to lie along one edge of a device containing a conductive groundplane;

FIG. 2 shows an embodiment of the present invention in schematic form;

FIG. 3 shows an embodiment of the present invention with a coaxial cable feed;

FIG. 4 shows an embodiment with a coplanar waveguide feed mechanism.

FIG. 5 shows an embodiment of the present invention with an integrated radio frequency integrated circuit;

FIG. 6 shows an embodiment with meandered and offset dipole limbs;

FIG. 7 shows the embodiment of FIG. 5 from above;

FIG. 8 shows a variation of the embodiment of FIG. 5 with additional reactive components;

FIG. 9 shows a further alternative embodiment of the present invention; and

FIG. 10 shows a plot of antenna efficiency against frequency for an embodiment of the present invention.

### DETAILED DESCRIPTION

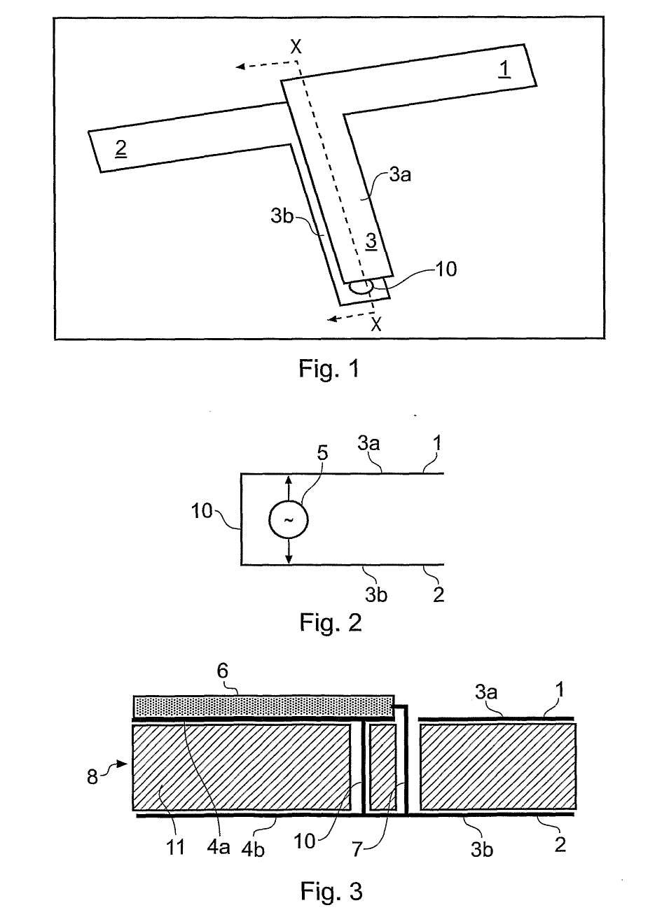

FIG. 1 shows a dipole comprising radiating arms 1, 2 connected to the ends of a parallel balanced transmission line 3 comprising two conductors 3a and 3b. A short circuit connection 10 connects both conductors and delimits the region which forms the antenna.

FIG. 2 shows a cross section XX through the arrangement of FIG. 1 where it is seen more clearly that the conductors 3a, 3b forming the parallel transmission line 3 are connected together by one or more short-circuit conductors 10. The dipole limbs cannot be physically differentiated from the transmission lines on this view (or that of FIG. 3) because they are coplanar and contiguous. The feed voltage is applied as shown by the schematic generator 5.

FIG. 3 shows a practical embodiment of the invention and can be related to FIG. 2 by the presence of the short-circuit 10, the transmission line 3a, 3b and the dipole limbs 1, 2. The antenna is provided with an unbalanced feed in the form of a coaxial cable with an outer sheath 6 and an inner core 7. In this embodiment the dipole elements 1, 2 are formed in the conductors of a double-sided printed circuit board 8 having outer conducting planes 4a, 4b and a dielectric inner region 11. In this embodiment the dipole limbs 1, 2 and the parallel plate transmission lines 3a, 3b and the groundplanes 4a, 4b are formed by photo-etching the copper conductors of the printed circuit board 8. The transmission lines 3a, 3b extend outwardly from respective regions which remain as the groundplanes for other electronic circuits mounted on the printed circuit board B. The grounding connection 10 delimits the region acting as the antenna from the remainder of the circuit board. The outer sheath of a coaxial feeding line 6 is electrically connected to one conductor 3a of the parallel transmission line 3 and the inner conductor 7 is connected through the insulating laminate 11 (e.g. a PCB substrate) and is connected to the other conductor 3b of the balanced transmission line 3. This arrangement converts the unbalanced mode in the coaxial cable into a balanced mode on the parallel transmission line 3 and corresponds to a circuit arrangement known as a balun. Many modern radio devices have unbalanced inputs/outputs, and it is therefore very useful to be able to feed a balanced antenna with an unbalanced feed so as to avoid the cost, space and insertion loss associated with the use of a separate balun.

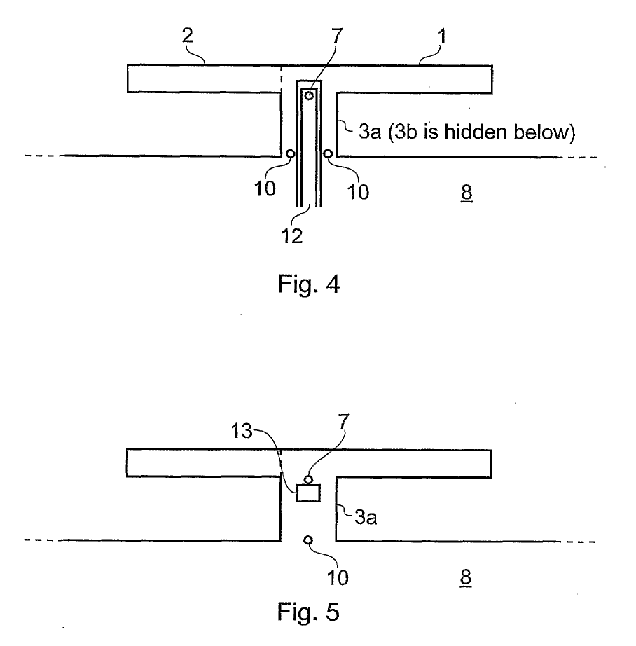

The embodiment in FIG. 4 shows the feeding line in the form of a microstrip transmission line 12.

It will be appreciated by those familiar with printed circuit fabrication techniques that in a practical realisation using microstrip coaxial or other feed line topologies the short circuit conductor 10 and the feed conductor 7 may be formed using plated-through holes (commonly known as vias) or conducting pins. Additional connections between the upper and lower conductors of the printed circuit board 8 are preferably made in the region of the groundplane adjacent to the antenna to reduce the possibility of excitation of unwanted currents inside the circuit area, or to prevent spurious signals present within the circuit area from being picked up by the antenna.

In a further embodiment shown in FIG. 5, a radio-frequency integrated circuit 13 is mounted on the feedline conductor 3 and connected directly to the feed 7 with no requirement for an intervening transmission line. The short circuit 10 is still required to limit the circuit area in which antenna currents may flow.

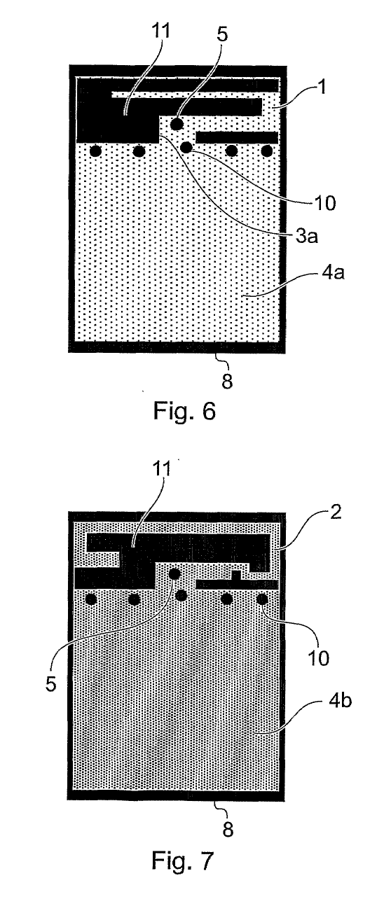

The radiating arms 1, 2 of the antenna need not be linear as in the embodiments of FIGS. 1 to 5. Instead, the radiating arms 1, 2 can be folded or meandered, as shown for example in the embodiments of FIGS. 6 and 7, which respectively show lower and upper surfaces of a printed circuit board with a conductive groundplane 4a, 4b covering most of each surface, such area being available for the mounting of associated electronic circuits.

FIG. 6 shows a printed circuit board made out of a dielectric substrate material 11 having a conductive groundplane layer 4 formed on its surface. A portion of the groundplane layer 4a near one end of the printed circuit board is removed so as to leave a meandering track that defines a first radiating arm 1. A feed 5 and short circuit connections 10 are also provided.

FIG. 7 shows the reverse side of the printed circuit board 8 of FIG. 6, which also has a conductive groundplane layer 4b formed thereon except in a region near an end of the printed circuit board where a portion of the groundplane layer 4b is removed so as to leave a meandering track that defines a second radiating arm 2. The feed 5 from FIG. 6 also connects to the radiating arm 2 through the substrate 11.

From a comparison between FIGS. 6 and 7, it can be seen that the radiating arms 1, 2 are slightly displaced relative to each other. In other words, the radiating arm 2 does not precisely follow the same path as the radiating arm 1. This arrangement provides improved frequency bandwidth. Moreover, the radiating arm 2 is somewhat longer than the radiating arm 1, which also helps to improve bandwidth.

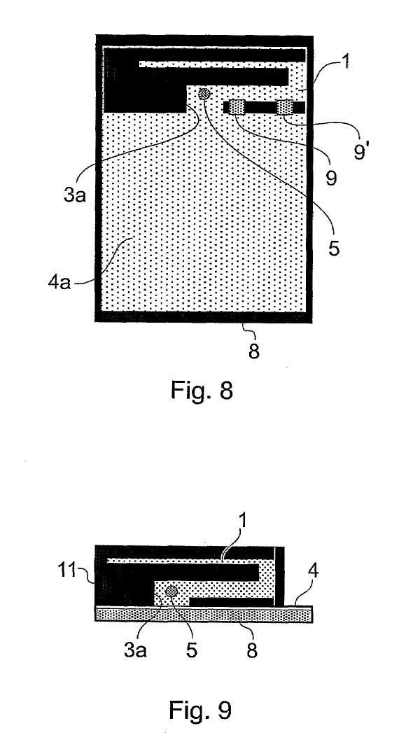

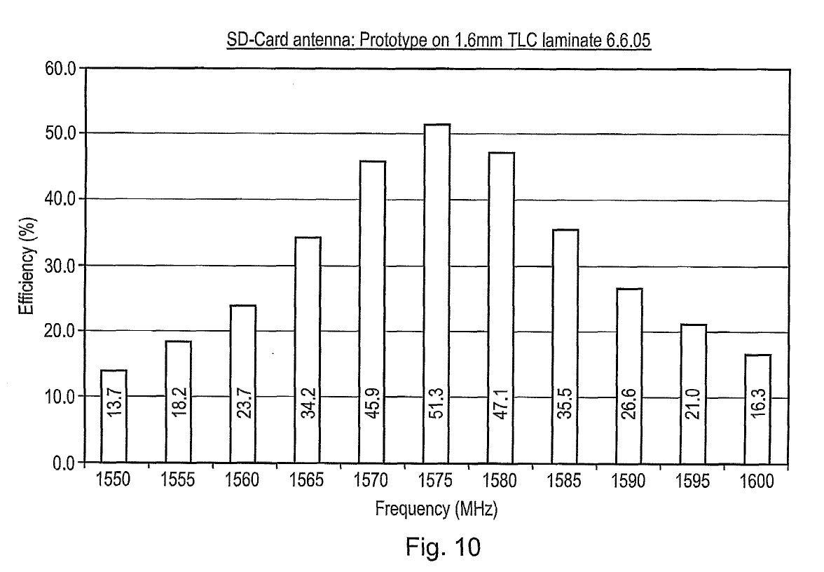

FIG. 8 shows the arrangement of FIG. 6 but with the addition of inductive or capacitive reactive components 9, 9′ on one side of the printed circuit board 8 connecting the radiating arm 1 to the groundplane 4a. Similar reactive components may also be located on the other side of the printed circuit board 8 between the radiating arm 2 and the groundplane 4b. The provision of such reactive components 9, 9′ can increase the bandwidth of the antenna and help to reject common mode interference.

Although the embodiments of FIGS. 6 to 8 have been found to work well, the fact that the antenna device is located in the same plane as the printed circuit board means that parts of the groundplanes 4a, 4b need to be removed from both sides of the board. It is normally desirable for as much of the substrate 11 as possible to be provided with a groundplane so as to allow the printed circuit board to be fully populated with components, thereby allowing the whole assembly to occupy as small an area as possible.

Accordingly, a particularly preferred embodiment of the invention is shown in FIG. 9, where a generic printed circuit board 8 with its conductive groundplanes 4 is shown in a horizontal orientation in cross-section. The antenna device of the present invention is then formed as a dipole, having radiating arms 1, 2 formed one on either side of a second dielectric substrate 11 and a common feed 5. Only the first arm 1 is shown in FIG. 8, the other arm being on the reverse side as in the foregoing descriptions. The dielectric substrate 11 is then mounted vertically or near-vertically on the PCB 8 with both feed line conductors 3a, 3b electrically contacting the groundplane 4. Because the antenna device is small, it does not add an unacceptable height profile to the device to which it is mounted.

FIG. 9 shows a plot of antenna efficiency against frequency for an antenna device as shown in FIG. 8, the material of the printed circuit board 8 being a Taconic® TLC laminate having an area of 24 mm by 8 mm and being 1.6 mm thick. The radiating arms 1, 2 are dimensioned for operation at 1.575 GHz (a typical GPS frequency). It can be seen that the efficiency exceeds 50% at the desired frequency.

For comparison, at the GPS frequency of 1.575 GHz a half wavelength dipole would be 95 mm long in free space and perhaps 70 mm long when printed on a PTFE-based substrate with a relative permittivity of 2.3.

1. A balanced antenna comprising a dipole with first and second radiating arms, the radiating arms being provided with a balanced transmission line for connection to a feed, the balanced transmission line comprising first and second conductors connected to each other by a short-circuit conductor, and in which the antenna device is fed by applying a potential difference across the first and second conductors.

2. An antenna device as claimed in claim 1, wherein the first and second radiating arms are formed as printed tracks on first and second opposed surfaces of a dielectric substrate.

3. An antenna device as claimed in claim 2, wherein the dielectric substrate is mounted vertically or near-vertically on a surface of a printed circuit board (PCB), the surface being provided with a conductive groundplane to which the first and second radiating arms are electrically connected.

4. An antenna device as claimed in claim 2, wherein the dielectric substrate is a PCB having first and second opposed surfaces each provided with a conductive groundplane except on predetermined opposing areas of the surfaces, and wherein the first and second radiating arms are formed on the predetermined areas of the surfaces.

5. An antenna device as claimed in claim 1, wherein the radiating arms have a meandering configuration.

6. An antenna device as claimed in claim 1, wherein the radiating arms are of different lengths.

7. An antenna device as claimed in claim 1, wherein the radiating arms do not follow identical paths.

8. An antenna device as claimed in claim 1, wherein the feed is an unbalanced feed.

9. An antenna device as claimed in claim 1, wherein the feed is a balanced feed.

10. An antenna device as claimed in claim 9, wherein the unbalanced feed comprises a coaxial cable, microstrip transmission line, coplanar waveguide or tri-plate waveguide.

11. An antenna device as claimed in claim 3, wherein at least one radiating arm is additionally connected to the groundplane by at least one inductive or capacitive component.

12. (canceled)

13. An antenna device as claimed in claim 1, wherein a radio-frequency integrated circuit is mounted on the transmission line

14. An antenna device as claimed in claim 1, wherein the antenna is mounted on an electronic memory card.

15. (canceled)
